(19) United States
(12) Patent Application Publication
(10) Pub. No.: US 2013/0026225 A1
(43) Pub. Date: Jan. 31, 2013

(54) TANK INFORMATION COMMUNICATION SYSTEM

(71) Applicants: F. Joseph Lingel, Lynnfield, MA (US); Michael Ashley, Ipswich, MA (US); William Bruns, North Andover, MA (US)

(72) Inventors: F. Joseph Lingel, Lynnfield, MA (US); Michael Ashley, Ipswich, MA (US); William Bruns, North Andover, MA (US)

(73) Assignee: UNITED PLASTIC FABRICATING, INC., North Andover, MA (US)

(21) Appl. No.: 13/559,907

(22) Filed: Jul. 27, 2012

Related U.S. Application Data
(60) Provisional application No. 61/512,123, filed on Jul. 27, 2011.
(60) Provisional application No. 61/538,371, filed on Sep. 23, 2011.

(51) Int. Cl. G06F 17/30

(52) U.S. Cl. 235/375

(57) ABSTRACT

A system is provided for display of tank information, the system comprising: a tank label, the tank label being displayed on a tank pump panel and comprising data including tank capacity, serial number; a computer readable code disposed on the tank label providing additional tank data and configured to communicate with a manufacturer of the tank.

### RELATED APPLICATIONS

This application claims the benefit of U.S. Provisional Application No. 61/512,123, filed Jul. 27, 2011, and U.S. Provisional Application No. 61/538,371, filed Sep. 23, 2011. Each of these applications is herein incorporated by reference in its entirety for all purposes.

### FIELD OF THE INVENTION

The invention relates to fluid supply tanks, and more particularly, to a fluid supply tank tag with a machine readable code and color coded fill information.

### BACKGROUND OF THE INVENTION

During operation and maintenance of tanks used in fire fighting and other uses, it is important to provide a fire fighter or technician access to the information pertaining to the water and or foam tanks installed on a fire apparatus. The serial number is required by the tank manufacturer for warranty or service purposes. Currently this information can be found by climbing on top of the apparatus and removing equipment to locate the serial number inscribed on tank enclosed in the apparatus body. The balance of the information required for operation of the tank including the tank capacities is not located anywhere on the apparatus or the tank. This information is necessary to determine fill and discharge capacities of the tanks. The fill rates for the tanks are also on the tag delineating the pressure and volume limitations for safe filling of the tanks. This information is contained in a manual as well but is normally not carried on the apparatus. Since fire apparatus have a minimum life of twenty years, this reduces the likelihood of the manuals being available. If the apparatus is at a service location for tank service or repairs, the tank manufacturer's contact information on the tag is useful and often required.

Furthermore, in emergency situations, clear visual cues must be provided so as to correlate data to specific items of information to specific tank functions or sections. Refilling the wrong part of a tank with the wrong fire retardant chemical, for instance, can institute extensive and dangerous delay while the tank is cleaned and the erroneously introduced material is removed. Known systems rely on operators to recognize the relationships between information and apparatus components.

What is needed, therefore, are techniques for obtaining this information easily and without increased risk of injury.

### SUMMARY OF THE INVENTION

One embodiment of the present invention provides a system for provision of tank information, the system comprising: a tank label, the tank label being displayed on a pump panel and comprising tank data; a computer readable code disposed on the tank label configured to communicate with a manufacturer of the tank. Another embodiment of the present invention provides such a system, wherein the computer readable code provides additional tank data.

A further embodiment of the present invention provides such a system wherein the additional tank data is selected from the group of additional tank data consisting of service history, certifications, engineering drawings, capacity data, and combinations thereof.

Yet another embodiment of the present invention provides such a system wherein the pump panel is disposed posterior to a truck cab.

A yet further embodiment of the present invention provides such a system wherein the computer readable code is a quick response code and provides a link to a website of the manufacturer.

Even another embodiment of the present invention provides such a system wherein the computer readable code is a bar code.

An even further embodiment of the present invention provides such a system wherein the computer readable code is a two dimensional code matrix.

Still another embodiment of the present invention provides such a system wherein the tank data is associated with a color.

A still further embodiment of the present invention provides such a system wherein the color corresponds to a color coded fill tower associated with the tank data.

Yet still another embodiment of the present invention provides such a system wherein the tank label is corrosion resistant.

A yet still further embodiment of the present invention provides such a system wherein the tank label is metallic or plastic.

One embodiment of the present invention provides a method for efficient conveyance of tank data, the method comprising: providing a tank label disposed on a vehicle having a tank; recording tank data on the tank label; Assigning identification colors to tank data on the tank label; and identifying tank fill towers with colors matching the identification colors.

Another embodiment of the present invention provides such a method further comprising providing a computer readable code on the label.

A further embodiment of the present invention provides such a method wherein the code provides tank data information.

Yet another embodiment of the present invention provides such a method wherein the code provides a link to a computer file containing information about the tank.

A yet further embodiment of the present invention provides such a method wherein the information about the tank comprises tank data is selected from the group of tank data consisting of service history, certifications, engineering drawings, capacity data, vehicle maintenance records and combinations thereof.

One embodiment of the present invention provides a truck, the truck comprising: a tank; a pump panel; a label disposed on the pump panel providing a computer readable code and tank information; a first color assigned to a portion of the tank data associated with a first tank fill tower; and the first tank fill tower being identified with the first color.

Another embodiment of the present invention provides such a truck according to claim 16, further comprising a second fill tower, the second fill tower being identified by a second color.

A further embodiment of the present invention provides such a truck wherein at least a portion of the first fill tower is the first color.

Yet another embodiment of the present invention provides such a truck wherein exposed portions of the first fill tower is the first color.

Even another embodiment of the present invention provides such a truck wherein the truck is an emergency vehicle.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a machine readable tank identification and data label configured in accordance with one embodiment of the present invention.

FIG. 2 is a block diagram illustrating a pump panel configured with a machine readable tank identification and data label configured in accordance with one embodiment of the present invention.

FIG. 3 is a block diagram illustrating a tank configured with plurality of color coded fill towers configured in accordance with one embodiment of the present invention.

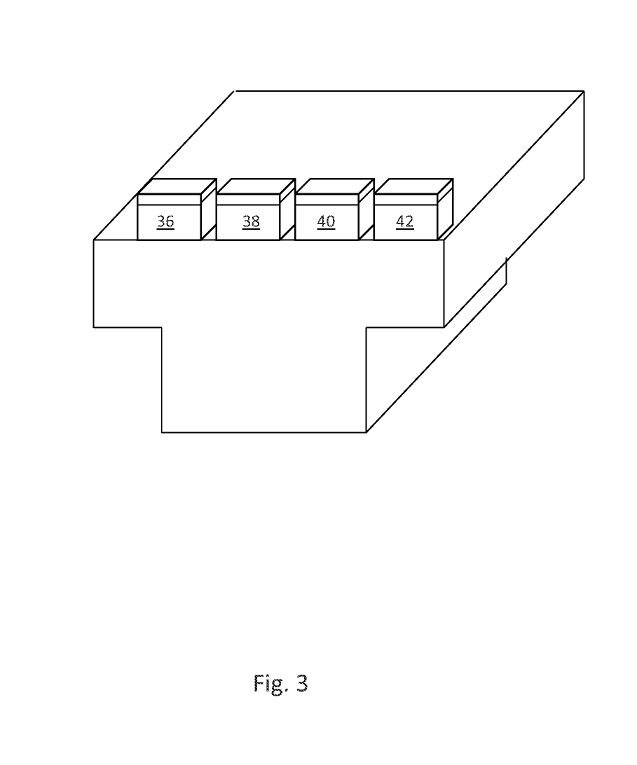

### DETAILED DESCRIPTION

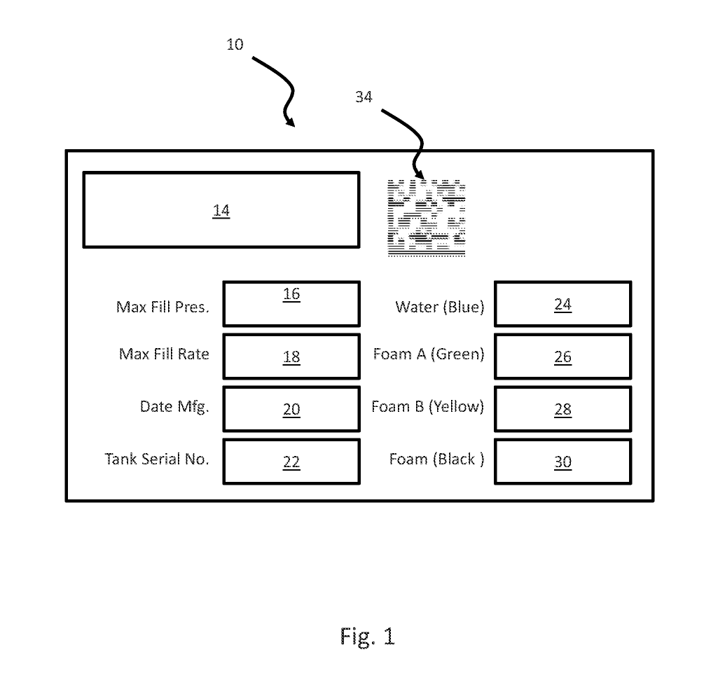

One embodiment of the present invention illustrated in FIG. 1 provides a tag 10 to be located on the operator's panel of a fire truck that delineates pertinent information for the on-board water and/or foam tanks. This information may include, but not be limited to, the tank serial number 22 manufacturing date of the tank 20, the tank capacities 24, 26, 28, 30 guidelines for proper operation including Maximum fill pressure 16, Maximum fill rate 18, contact information for the tank manufacturer, and the date manufactured. This information is not, otherwise, readily available for water and or foam tanks that are installed and normally concealed inside the body of the fire apparatus. In one embodiment, the tank capacities 24, 26, 28, 30 may be associated with colors, and corresponding fill towers are identified by the color of associated color. In such embodiments the colors may be verbally identified on the tag as illustrated in FIG. 1 or the information may be printed in the associated color.

A tag 10 configured in accord with such an embodiment may be constructed of a durable material such as metal or plastic and marked or engraved with the information once the tank is designed. Alternatively, the tag may be pre-marked/pre-engraved with the categories of information to be entered with the actual tank information.

Such a tag 10 allows for the rapid access to the tank information regarding the water and or foam tanks on the fire apparatus. Since fire apparatus vary in capacities, a fire fighter not familiar with the apparatus needs to know the capacities and proper operational guidelines. In an emergency situation, the fire fighter operating the pump would have the necessary information to determine the water and or foam based on the capacity information allowing the duration of the water and or foam supply to be determined.

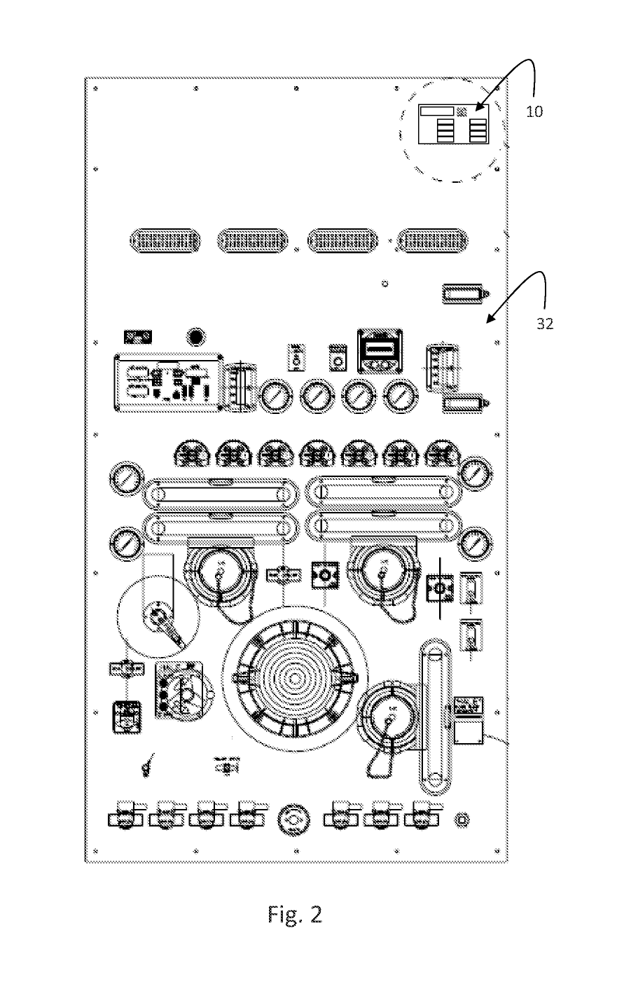

The apparatus manufacturer, in one embodiment of the present invention illustrated in FIG. 2, affixes the tag 10 to the pump panel 32 when manufacturing the apparatus. The tag 10 will prepared by the tank manufacturer and shipped to the apparatus manufacturer with the tank and supporting documents normally provided for installation in a visible location on the pump panel 32.

One embodiment of the invention allows a fire fighter or technician to access information pertaining to the water and or foam tanks. The tag 10 is affixed to the pump panel 32 so the information is accessible during the operation and maintenance of the tanks. The tag, in one embodiment will be approximately 3″×5″ in size and located on the lower portion of the pump panel where the pump operator is positioned during fire operations. One skilled in the art will appreciate that other sizes suitable to the panel location and size may be used.

The pump panel 32 is normally located on the driver's side of the apparatus body behind the vehicle cab and contains the gauges and controls for the operation of the pump. The pump panel 32 can also be centrally located on top of the pump behind the center of the cab or in the rear of the apparatus on either side or the rear. The information contained on the tag 10 provides the critical information to the pump operator on the capacities of the tanks during a fire that allows the pump operator to determine the proper mixture of foam and water that will be available over a specific period of time. This information is critical during a life saving situation and is necessary since most fire apparatus do not have the same tank sizes and the pump operator may not be familiar with the particular apparatus being utilized during the emergency.

Further, the information contained on the pump panel tag 10 pertaining to the tank is useful during maintenance procedures. The pump panel tag 10 is, in one embodiment, equipped with a QR code 34 (Quick Response Two dimensional matrix bar code label) that is capable of being read using a smart phone technology. This will allow the fire department to be linked to additional information regarding operation and maintenance of the tank. Scanning the QR code 34 using smart phone technology eliminates the need to manual entry of information under emergency and non-emergency conditions to retrieve the required data. This is not only faster, but eliminates the possibility of human error from mistyping. Other computer or device readable materials may also be used as would be understood by one skilled in the art. This further ensures that the URL embedded in the bar code always directs the user to the most up to date information. The fire department will be able to do other more routine tasks faster and more accurately such as registering the tank for warranty coverage. In addition, the tag provides the ability to print out a copy of the tank capacity certification certificate as required by NFPA standard 1901, or request service or warranty coverage on the product. In addition the fire department will be able to request to receive future service and safety bulletins as well as engineering drawings on their product. The fire department will be able to link the manufacturing information with the tank into their in-house software maintenance programs.

The capacity information 24, 26, 28, 30 contained on the tag 10 is, in one embodiment, vital information that could seriously endanger and contribute to the loss of life and/or property if it were not readily available. Since the pump operator is supplying water and/or foam to the fire fighters engaged in the suppression of the fire, an unattended interruption or stoppage of the water and/or foam could be catastrophic. Since pumps operate in gallons or liters per minute, the pump operator must know the precise capacity of the tank and flow of the water and/or foam supply to the fire scene so a calculation can be made to determine the duration of the fire-fighting efforts prior to attaching to an external water supply.

An embodiment of the present invention provides water/foam fill towers on fire truck tanks manufactures from materials of various colors so as to distinguish the contents of various tanks or tank sections to which are connected towers 36, 38, 40, 42.

In one embodiment, each tower 36, 38, 40, 42 is colored instead of black or natural (off white). In such an embodiment, a blue tower may be assigned for water, while other colors (such as red, black, yellow, green, blue or other readily identifiable color) are assigned to various types of foam additives. These colors are selected to match the identifying color of the key information 24, 26, 28, 30.

By using the colors, fire fighters will know which tower 36, 38, 40, 42 to open and add the proper liquid to avoiding what could be a hazardous situation if the wrong liquid were poured into the wrong tower.

In one embodiment, the manufacturer of the tower substitutes black or natural (off white) plastic with colored plastic in accordance with the requirement for the liquid.

The colored towers can be interchanged if the fire department changed the foam they were using in a certain tank.

The fire fighter would open the lid and add the proper liquid based on the color of the fill tower.

Any tank application in which fill towers are used could adapt to colored fill towers to designate different liquids.

The color makes the fill towers easy to identify and will standardize which liquid goes with which color—water will be blue towers, etc.

There are generally one or more fill towers on each tank for various water and foam additives. The standardizing of colors eliminates the need to try and read the numerous non-standard labels used today. In some cases, no labels exist at all.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

We claim:

1. A system for provision of tank information, the system comprising:
a tank label, said tank label being displayed on a pump panel and comprising tank data;
a computer readable code disposed on said tank label configured to communicate with a manufacturer of said tank.

2. The system according to claim 1, wherein said computer readable code provides additional tank data.

3. The system of claim 2 wherein said additional tank data is selected from the group of additional tank data consisting of service history, certifications, engineering drawings, capacity data, and combinations thereof.

4. The system according to claim 1 wherein said pump panel is disposed posterior to a truck cab.

5. The system according to claim 1 wherein said computer readable code is a quick response code and provides a link to a website of said manufacturer.

6. The system of claim 1 wherein said computer readable code is a bar code.

7. The system of claim 1 wherein said computer readable code is a two dimensional code matrix.

8. The system according to claim 1 wherein said tank data is associated with a color.

9. The system according to claim 8 wherein said color corresponds to a color coded fill tower associated with said tank data.

10. The system of claim 1 wherein said tank label is corrosion resistant.

11. The system of claim 1 wherein said tank label is metallic or plastic.

12. A method for efficient conveyance of tank data, said method comprising:
Providing a tank label disposed on a vehicle having a tank;
Recording tank data on said tank label;
Assigning identification colors to tank data on said tank label; and
Identifying tank fill towers with colors matching said identification colors.

13. The method of claim 12, further comprising providing a computer readable code on said label.

14. The method of claim 13 wherein said code provides tank data information.

15. The method of claim 13 wherein said code provides a link to a computer file containing information about said tank.

16. The method of claim 15 wherein said information about said tank comprises tank data is selected from the group of tank data consisting of service history, certifications, engineering drawings, capacity data, vehicle maintenance records and combinations thereof.

17. A truck, said truck comprising:
a tank;
a pump panel;
a label disposed on said pump panel providing a computer readable code and tank information;
a first color assigned to a portion of said tank data associated with a first tank fill tower; and
said first tank fill tower being identified with said first color.

18. The truck according to claim 17, further comprising a second fill tower, said second fill tower being identified by a second color.

19. The truck according to claim 17, wherein at least a portion of said first fill tower is said first color.

20. The truck according to claim 17 wherein exposed portions of said first fill tower is said first color.

21. The truck according to claim 17, wherein said truck is an emergency vehicle.
